(19) United States
(12) Patent Application Publication
(10) Pub. No.: US 2006/0008637 A1
(43) Pub. Date: Jan. 12, 2006

(54) Running surface for winter sports gear

(75) Inventor: Urs Geissbuhler, Thun (CH)

Correspondence Address: SHOEMAKER AND MATTARE, LTD, 10 POST OFFICE ROAD - SUITE 110, SILVER SPRING, MD, 20910, US

(73) Assignee: IMS Kunststoff AG, Worb (CH)

(21) Appl. No.: 11/171,480

(22) Filed: Jul. 1, 2005

(30) Foreign Application Priority Data
Jul. 2, 2004 (EP) 04015627.5

(51) Int. Cl. B32B 5/16

(52) U.S. Cl. 428/323

(57) ABSTRACT

The invention relates to a running surface for winter sports gear, containing an additive of at least one or more fullerenes. By adding a comparatively small amount of fullerene, improved sliding properties are effected, so that the addition of carbon black and/or graphite can be omitted, enabling one to produce colorations of the running surface.

### BACKGROUND OF THE INVENTION

The invention relates to a running surface for winter sports gear, winter sports gear with such a running surface, a composition for producing such a running surface, and the use of one or more fullerenes as an additive to such a running surface.

Running surfaces for winter sports gear such as for example all types of skis (for example, cross country skis, alpine skis, telemark skis), snow boards, skiboards, sleds, etc., in general all running surfaces which are intended for sliding on snow or ice, are preferably produced from a water-repellent plastic, for example polyethylene (PE). The sliding mechanism of these running surfaces on snow and/or ice is currently not definitively understood. But it is assumed that upon contact of the tips of the rough spots of the running surfaces with snow and/or ice crystals frictional heat is generated which leads to local melting of the snow and/or ice crystals. The locally formed meltwater leads to hydrodynamic lubrication conditions, by which the coefficients of kinetic friction of often 0.02-0.05 which can be achieved when sliding on snow can be explained (Schimbo, M.: Friction on snow of ski soles, unwaxed and waxed, Scientific Study of Skiing in Japan) Society of Ski Science; Hitachi, Tokyo, pages 99-112). Without hydrodynamic lubrication conditions the attainable coefficients of kinetic friction are generally 10 times greater.

It has been shown in practice that at higher speeds the locally formed meltwater has the tendency to distribute itself over larger area of the running surface; this can lead to an undesirable “suction effect” which reduces the sliding speed. When materials such as for example carbon black and/or graphite, known for example from CH 657 993 A and CH 660 018 A, are added, the sliding capacity of the running surfaces can be improved and the “suction effect” can be reduced or prevented. Currently it is assumed that the improved sliding properties and reduction/prevention of the “suction effect” are due to thermal conductivity which is increased compared to an unmodified plastic matrix and which can be achieved by the indicated additives.

Using boron, boron compounds, and nitrides for purposes of improvement of sliding properties is also known from EP 1 053 768. Furthermore U.S. Pat. No. 6,063,739 discloses the addition of fluorographite.

The disadvantage in these known materials is the relatively large amounts of material required. Thus, for example, carbon black (for example, industrial carbon black from the “Printex” series (Degussa), typically with a toluene-extractable proportion of less than 0.1% for example) or graphite in proportions of roughly 5% by weight up to roughly 30% by weight are added; in the case of adding carbon black, generally only starting with an added amount of more than 3-4% by weight is any effect at all detectable. The addition of additives in proportions of up to 30% by weight however is disadvantageous due to the resulting degradation of the mechanical properties of the plastic matrix. Moreover it is not possible to attain non-black surfaces by adding graphite, carbon black or the like in such large amounts.

### SUMMARY OF THE INVENTION

Therefore the object of the invention is to avoid the disadvantages of what is known, especially therefore to devise a running surface for winter sports gear which for comparable sliding properties which are further improved compared to the prior art has only a smaller proportion of an additive which improves sliding properties. Moreover such a running surface will enable non-black coloring, will be as simple to produce and process as possible, and will satisfy the current durability requirements of the ski industry.

This object is achieved by a running surface for winter sports gear, winter sports gear with such a running surface, a composition for producing such a running surface, and the use of one or more fullerenes as an additive to such a running surface as described below. These running surfaces are typically produced from and/or contain essentially a plastic, especially polyethylene (PE).

The invention relates to running surfaces for winter sports gear such as for example all types of skis (for example, cross country skis, alpine skis, telemark skis), snow boards, skiboards, sleds, etc., in general all running surfaces which are intended for sliding on snow or ice, the running surface containing an additive of at least one or more fullerenes.

Here and hereinafter fullerenes are defined as all representative of the class of especially cage-like macromolecules which are built up from five and six rings and which consist solely of carbon. The best known and most stable representatives of this class are especially C₆₀ (buckminster fullerene which is preferred within the framework of the invention (in mixtures with other fullerenes) can be used), C₇₀, C₇₆, C₈₀, C₈₂, C₈₄, C₈₆, C₉₀, C₉₄. Fullerides (fullerenes with a negative charge on the cage), endohedral and exohedral fullerenes (fullerenes with foreign molecules inside or outside of the cage) are also defined as fullerenes here and below. Likewise heterofullerenes (fullerenes with incorporated non-metal atoms in the cage structure) and metcars, as well as other functionalized fullerenes (and optionally carbon nanotubes) are fullerenes which are suitable within the framework of the invention as long as they have sufficient stability in order to satisfy current requirements of the ski industry for durability of running surfaces.

Surprisingly, an improvement of the sliding properties of the running surfaces was found by the addition of fullerenes, with addition of less than 10% by weight, preferably less than 5% by weight, for example only 0.02% by weight to 5% by weight, preferably from 0.02% by weight to 1% by weight, especially preferably from 0.05% by weight to 0.5% by weight, relative to 100 parts by weight of the plastic.

The fullerenes are used in a form as pure as possible as an additive to the running surface. Preferably the carbon content of the fullerene additive consists essentially solely of fullerenes. Fullerenes can be ordered commercially in pure form and as mixtures of these fullerenes in high purity. These isolated, pure fullerenes or mixtures of these fullerenes can be used preferably within the framework of the invention.

Fullerenes dissolve in organic solvents with a partially characteristic coloring. In the current plastic matrix for running surfaces, polyethylene (PE), fullerenes are present in “dissolved” form.

Moreover the partially characteristic coloring of fullerene solutions enables preparation of non-black running surfaces with a color which can be varied depending on the fullerene used. Such a non-black coloration is not possible with the currently used large amounts of added carbon black and/or graphite.

The durability of running surfaces containing especially for example the common fullerenes C₆₀ and C₇₀ as the main components of the fullerene additive moreover satisfies the durability requirements of the ski industry: Within two years after manufacture, no significant change was observed in the properties of running surfaces with these additives. This may likewise be due to the fact that “fullerenes” are embedded in “dissolved” form in the plastic matrix of the running surface, especially of the polyethylene matrix.

According to one especially preferred embodiment the running surface is composed essentially of a plastic, especially polyethylene (PE). Ultra high molecular weight (UHMW) polyethylene (PE) is especially preferably used, for example with a molecular weight range from roughly 2×10⁶ g/mole to roughly 15×10⁶ g/mole. A running surface according to the invention is preferably produced in a pressurized sintering process. But it is also of course possible to produce a running surface according to the invention for example by means of extrusion, for example of polyethylene (PE) with a molecular weight from roughly 2×10⁵ g/mole to 8×10⁵ g/mole. The choice of other water-repellent plastic materials which can be used as a replacement or additive to polyethylene (PE) within the framework of the invention corresponds to the routine of one skilled in the art.

According to another preferred embodiment of the invention, one or more other additives, especially selected from the group consisting of carbon black, graphite, boron, boron compounds nitrides and fluorographite can be added to the running surface according to the invention. It was established in tests that especially by the synergistic effect of these additives with fullerenes a further improvement of sliding properties can be effected.

The invention furthermore relates to a composition for producing the above described running surfaces, comprising a plastic, especially polyethylene (PE) or at least one or more fullerenes and the use of one or more fullerenes as an additive to the running surface of winter sports gear.

The process for producing a running surfaces according to the invention for winter sports gear is preferably a sintering, especially a pressurized sintering or extrusion process, comprising the step of adding an additive of at least one or more fullerenes.

### DESCRIPTION OF THE PREFERRED EMBODIMENT(S)

The invention is explained below by way of example by preferred embodiments, without the invention necessarily being limited thereto.

### EXAMPLE 1

### Comparison Example, Prior Art

15 parts by weight carbon black Printex A (Degussa) with a particle size of 20 nm and 85 parts by weight low pressure polyethylene Hostalen GUR 4120 (molecular weight of 5×10⁶) are intimately mixed in a mixer for 20 minutes and then sintered under pressure in a cylindrical mold under standard conditions such as given for example in the Hoechst brochure “Hostalen GUR” (HKR112-7089C12299/14) into a homogenous cylindrical sintered compact. After cooling, a coherent strip—the running surface—in the desired thickness of for example 1.5 mm is peeled off the compact. It is afterwards roughened on one side and prepared by an oxidizing flame for cementing to the winter sports gear.

### EXAMPLE 2

### According to the Invention

According to a process which is analogous to example 1, 100 parts by weight Hostalen GUR 4170 with 0.1 parts by weight of a fullerene mixture (containing: C₆₀ (77% by weight), C₇₀ (20% by weight), C₇₆ (1% by weight), C₇₈ (1% by weight), C₈₄ (1% by weight) are processed into a running surface. The running surface has an orange red-brownish, translucent homogeneous color.

### EXAMPLE 3

### According to the Invention

According to a process which is analogous to example 1, 100 parts by weight Hostalen GUR 4150 with 0.1 parts by weight of a fullerene mixture (containing: C₆₀ (77% by weight), C₇₀ (20% by weight), C₇₆ (1% by weight), C₇₈ (1% by weight), C₈₄ (1% by weight) and 1 part by weight boron nitride powder (spec. surface of 6.3 m²/g, CAS number 10043-11-5) are processed into a running surface. The running surface has an orange red-brownish, opaque color.

Measured Values, Physical Properties

The running surfaces according to examples 1 to 3 were studied for certain characteristic physical properties (Table 1). The results found for the embodiments of the invention according to examples 2 and 3 are comparable to those of the comparison example 1 and indicate similar or improved sliding properties:

TABLE 1
Selected physical properties of the running surfaces according
to examples 1 to 3

| | PROPERTIES | | |
|---|---|---|---|
| | Density | Melting peak min. | Melt enthalpy |
| | (g/cm³) | (° C.) | (J/g) |
| Meas. method | DIN 53479 | DSC | DSC |
| Meas. value | 1.0019 ± 0.0008 | 136 | 92.4 |
| Example 1 | | | |
| Meas. value | 0.9275 ± 0.0013 | 136 | 97.1 |
| Example 2 | | | |
| Meas. value | 0.9401 ± 0.0004 | 136.5 | 102 |
| Example 3 | | | |

Sliding Properties:

Skis were produced equipped with running surfaces according to the preceding examples 1 to 3. Aside from the different running surfaces, the skis had identical structures. The skis which were provided with the running surfaces of the invention according to example 2 and 3 yielded comparable or improved sliding results relative to a ski provided with a running surface according to comparison example 1.

1. A running surface for winter sports gear, containing an additive comprising at least one or more fullerenes.

2. A running surface as claimed in claim 1, produced from and/or essentially containing a water-repellent plastic.

3. A running surface as claimed in claim 2, wherein said additive comprises less than 10% by weight of the plastic.

4. A running surface as claimed in claim 2, wherein said additive comprises less than 5% by weight of the plastic.

5. A running surface as claimed in claim 2, wherein said additive comprises 0.02% to 5% by weight of the plastic.

6. A running surface as claimed in claim 2, wherein said additive comprises 0.02% to 1% by weight of the plastic.

7. A running surface as claimed in claim 2, wherein said additive comprises 0.05% to 0.5% by weight of the plastic.

8. A running surface as claimed in claim 1, wherein said additive comprises fullerene C₆₀ as its main component.

9. A running surface as claimed in claim 1, furthermore containing one or more additives, selected from the group consisting of carbon black, graphite, boron, boron compounds, nitrides and fluorographite, and mixtures thereof.

10. A winter sports gear with a running surface as claimed in claim 1.

11. A composition for producing a running surface as claimed in claim 1, comprising a plastic and one or more fullerenes.

12. A method for producing a running surface for winter sports gear, especially in a sintering or extrusion process, said method comprising a step of adding an additive comprising one or more fullerenes to said running surface.

13. A running surface as claimed in claim 1, wherein said plastic is polyethylene.

14. A composition as claimed in claim 11, wherein said plastic is polyethylene.
